(19) United States
(12) Patent Application Publication
(10) Pub. No.: US 2005/0196667 A1
(43) Pub. Date: Sep. 8, 2005

(54) Anode design for a prismatically wound LiMnO2 cell

(75) Inventor: Christo Brand, North Vancouver (CA)

Correspondence Address: WOOD, HERRON & EVANS, LLP, 2700 CAREW TOWER, 441 VINE STREET, CINCINNATI, OH, 45202, US

(73) Assignee: EaglePicher Technologies, LLC, Joplin, MO (US)

(21) Appl. No.: 10/792,242

(22) Filed: Mar. 3, 2004

(51) Int. Cl. H01M 2/18; H01M 6/10; H01M 2/26; H01M 2/02

(52) U.S. Cl. 429/130; 429/139; 429/94; 429/176; 429/161

(57) ABSTRACT

A prismatic cell for implantable medical devices includes an elongated anode and cathode folded together to form a prismatic cell. The anode includes an anode tab which does not extend to the bottom edge of the anode, with heat-resistant tape on the opposite side of the anode, likewise not extending to the bottom edge of the anode. This provides a strip of anode material below the anode tab which acts as a current collector reducing the increase in impedance as the cell is discharged.

### FIELD OF THE INVENTION

The batteries which power implantable medical devices, such as cardiac defibrilators, must meet relatively demanding performance requirements. Power output to size is critical. As a result, many of these batteries are prismatically shaped, in other words, having a generally rectangular cross section with two elongated sides and two narrow sides. The cells are formed by an elongated anode and an elongated solid cathode with a separator between the two. These are wound or folded to assume the prismatic shape. A typical chemistry employed is lithium/manganese dioxide which uses a lithium anode, a manganese dioxide active material and an electrolyte. Other typical battery chemistries include Li/AgVO and Li/FeS₂.

These batteries include a cathode tab to connect the cathode to the positive terminal, and an anode tab to connect the anode to the negative terminal usually through the metal casing.

The anode tab is a strip of conductive metal such as nickel which is attached to the anode by crimping, or the like. The tab generally extends the entire width of the anode. With prismatic cells, the placement of the anode tab is a problem. It cannot be easily placed on the outside of the wrap beyond the end of the cathode without sacrificing cathode active material. The tab must be placed on the long face of the prismatic cell to facilitate manufacturing. To insure safety of the prismatic cell under short circuit conditions, the side of the lithium opposite the tab facing the center of the cell must be taped with a heat-resistant tape. Since the tape has low porosity, this portion of the anode is inactive during discharge which results in the cathode further inside the wrap totally depleting the anode resulting in all of the current being carried by an embedded nickel wire which runs the length of the anode. As a result, the cell impedance rises and the cell therefore has a reduced capacity.

### SUMMARY OF THE INVENTION

The present invention is premised upon the realization that this impedance rise can be reduced by positioning the anode tab along the anode so that the bottom edge of the anode tab does not extend the entire width of the anode. The heat-resistant tape is, in turn, positioned on the opposite side of the anode overlying the area of the anode tab and likewise not extending to the bottom edge of the anode. This provides a small portion of the bottom edge of the anode uncovered by the tape or the anode tab. This reduces the impedance rise in the cell as the cell is discharged and increases the capacity of the cell. Further, this acts to insure greater uniformity in groups of cells.

In a preferred embodiment, the present invention is a spirally wound lithium/manganese dioxide cell. Preferably, the anode tab is spaced from the bottom edge of the anode by at least about 0.25 inches with the heat-resistant tape spaced from the bottom edge at least about 0.2 inches, leaving a 0.2-inch strip of anode material below the tape.

The objects and advantages of the present invention will be further appreciated in light of the following detailed description and drawings in which

### BRIEF DESCRIPTION OF THE DRAWINGS

FIG. 1 is an unrolled side view of a lithium anode with an anode tab.

FIG. 2 is an enlarged cross section taken at line 2-2 of FIG. 1.

FIG. 3 is a plan view of a prismatic cell according to the present invention.

FIG. 4 is a cross section taken along lines 4-4 of FIG. 3.

FIG. 5 is an enlarged portion of encircled areas of FIG. 4.

### DETAILED DESCRIPTION OF THE INVENTION

The present invention is an anode 11 as well as a prismatic cell 12 which is specially designed to reduce impedance as the cell is discharged. As shown in the Figures, the prismatic cell 12 includes a casing 14 which houses an anode/cathode roll 16. The anode/cathode roll 16 includes the anode 11, solid cathode 18 and a separator 20.

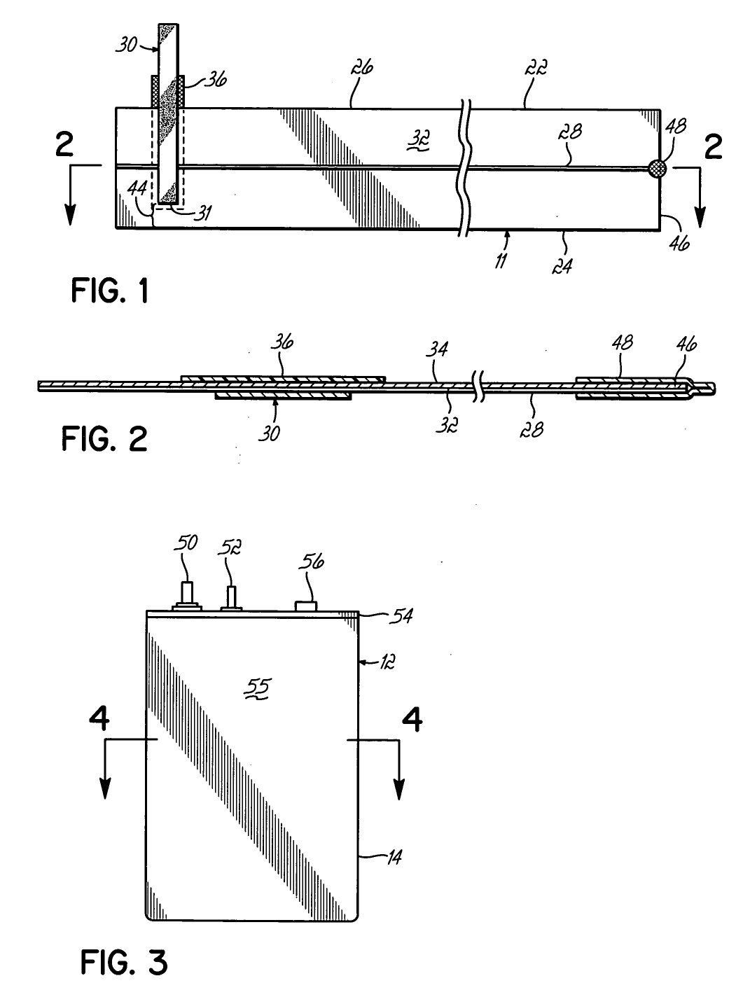

As shown more particularly in FIG. 1 and FIG. 2, the anode 11 includes an elongated metal strip 22 having a bottom edge 24 and a top edge 26. The anode is a reactive metal relative to the cathode active material. In the preferred embodiment, the metal is lithium. Running down the long axis of strip 22 is an embedded nickel wire 28 which acts as a current collector. More than one wire can be employed, if desired. An anode tab 30 is attached to a first side 32 of strip 22. As shown, this is attached by simply crimping portions of the nickel tab 30 into the metal strip 22.

The anode tab 30 extends partially down the width of the strip 22 and is separated from the bottom edge 24. The distance between the bottom edge 31 of tab 30 and bottom edge 24 can vary depending upon the particular battery and will generally be from about 0.2 to about 0.3 inches.

Attached to the second side 34 of strip 22 is a insulating tape 36 which is shown with broken lines in FIG. 1. This insulating tape 36 extends beyond the edge 31 of nickel anode tab 30. It does not extend to the bottom edge 24 of the metal strip 22. This leaves a small area 44 below the tape and below the nickel anode tab 30 on strip 22 which is covered by neither tape nor nickel anode tab. Preferably this area 44 should be about 0.15 to 0.25 inches.

As shown in FIG. 2, the distal end 46 of strip 22 is also covered with an insulating tape 48 the end of which covers nickel wire 28. The insulating tape is a nonporous polymeric film coated on one side with a pressure sensitive adhesive. One preferred material is a PTFE impregnated fiberglass.

The cathode can be any solid cathode. Generally such cathodes are a stainless steel mesh coated with a cathode active material such as manganese dioxide or vanadium dioxide. As shown in FIG. 5, cathode tab 49 is welded to the stainless steel mesh and covered with insulating tape 51a/51b on either side of the tab 49.

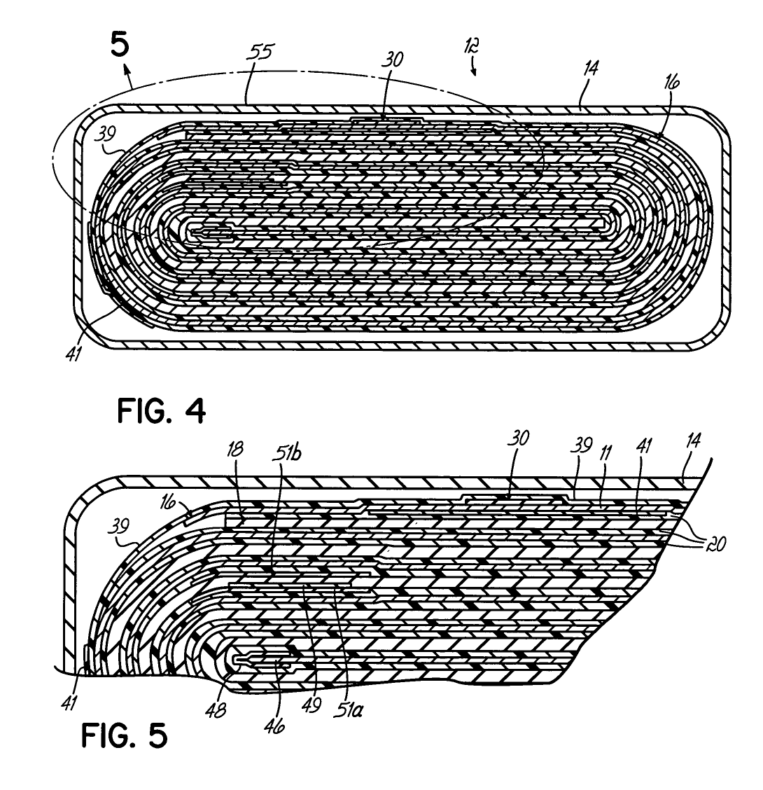

To form the cell 12, the separator 20 is positioned over the end 46 of strip 22. The cathode 18 is then rolled together with a separator 20 and anode 11 to form the anode/cathode roll 16 as shown in FIGS. 4 and 5. The formed roll 16 has an insulating layer 39 of separator which is sealed with tape 41. This is positioned into the casing 14. The cathode tab 49 is welded to positive terminal 50 and the nickel anode tab is in turn welded to a long side 55 of the cell casing 14. Cover 54 includes a negative terminal 52. Positive terminal 50 of the cover is sealed on the top and the casing 14 which is filled with electrolyte through a fill port 56.

The electrolyte used in the present invention will generally be a metal salt dissolved in an organic solvent. Suitable metal salts will, of course, depend upon the anode and cathode active material. Typical electrolytes include: LiClO₄ or LiAsF dissolved in a mixture of propylene carbonate, ethylene carbonate and dimethoxyethane.

To test the cell design of the present invention, twenty lithium/manganese dioxide cells were built with identical materials and procedures. The cell had a capacity of 2-Ah and was a prismatic format. The cell was designed to be suitable for implantable defibrilator application. The anode tab, instead of being the full width of the anode, stopped 0.25 inches from the bottom edge of the anode. Safety tape was placed 0.2 inches from the lower edge of the anode. The size of the tab was 0.200 inches by 0.003 inches and the size of the tape was 0.350 inches by 0.006 inches. The cells were then divided into two groups of ten cells each. One group was tested according to a fast run down protocol and the other group was tested under short circuit conditions.

The test results showed that the previously observed increase in impedance was no longer present and the average capacity of cells was higher and more uniform. All the cells tested under short circuit conditions passed safely. Thus, as shown above, the cell design of the present invention reduces impedance and provides higher capacity and more uniform capacity in cells.

The preferred embodiment shows a single anode with a single anode tab. However, the present invention can also be employed in cells with multiple anodes each having an anode tab as well as cells having multiple anode tabs attached to a single anode.

Having described this invention, its advantages and parameters, it will be obvious to a person of ordinary skill in the art, in view of the above description, that variations thereof may be made without departing from the spirit and scope thereof.

1. A prismatic cell having
an elongated anode having a long axis;
an elongated cathode having a long axis;
a separator between said anode and said cathode wherein said anode and cathode are folded together separated by said separator, said cell having two long sides and two narrow sides;
an anode tab attached to a first side of said anode; and
insulation tape attached to a second side of said anode opposite said anode tab wherein a bottom edge of said tab is above a bottom edge of said anode and a bottom edge of said insulation tape is above said bottom edge of said anode.

2. The prismatic cell claimed in claim 1 wherein said prismatic cell is folded into a spiral.

3. The prismatic cell claimed in claim 1 wherein said prismatic cell is folded in a serpentine configuration.

4. The prismatic cell claimed in claim 1 wherein said anode further comprises a metal wire extended along the long axis of said anode.

5. The prismatic cell claimed in claim 1 wherein said anode is lithium.

6. The prismatic cell claimed in claim 1 wherein said tape extends from about 0.15 to about 0.25 inches from said bottom edge of said anode.

7. The prismatic cell claimed in claim 1 having a metal casing wherein said casing has two long sides and two narrow sides and a bottom, and said anode tab is welded to one of said long sides.
